(19) United States
(12) Patent Application Publication
(10) Pub. No.: US 2017/0108465 A1
(43) Pub. Date: Apr. 20, 2017

(54) METHODS FOR DETECTION OF BIOMARKERS IN DISEASE SCREENING

(71) Applicant: The Texas A&M University System, College Station, TX (US)

(72) Inventors: Ronald D. Macfarlane, College Station, TX (US); Katharine G. Wigginton, College Station, TX (US)

(21) Appl. No.: 15/295,867

(22) Filed: Oct. 17, 2016

Related U.S. Application Data
(60) Provisional application No. 62/242,805, filed on Oct. 16, 2015.

(51) Int. Cl. G01N 27/447

(52) U.S. Cl. CPC G01N 27/44739; G01N 27/44747; G01N 27/44791

(57) ABSTRACT

The claimed invention is directed to a system and method for the detection of biomarkers in disease using various methods of analysis to identify biomarkers involved either directly or indirectly in health and disease by comparing the electrophoresis profiles from the biofluid of diseased and healthy individuals.

### CROSS-REFERENCES TO RELATED APPLICATIONS

This application claims the benefit of U.S. Provisional Patent Application Ser. No. 62/242,805, filed on Oct. 16, 2015, which is incorporated herein by reference in its entirety.

### STATEMENT REGARDING FEDERALLY SPONSORED RESEARCH AND DEVELOPMENT

This invention was made with government support under Grant No. HL068794 awarded by the National Institutes of Health. The government has certain rights in the invention.

### BACKGROUND OF THE INVENTION

A major goal of the 21st century is to mitigate disease and healthcare costs. Coronary artery disease (CAD) kills 370,000 Americans and costs the United States $109 billion each year. More accurate screening tools are needed to ameliorate CAD related morbidity and mortality. An established clinical tool, the 10-Year Framingham Risk Score (FRS), calculates the percent risk an individual has of developing CAD or having a cardiac event in the next 10 years. As established in recent literature, the FRS has a very low accuracy of predicting CAD on an individual basis. As such, more accurate screening tools are needed. The development of new tests for CAD may lead to screening procedures for other diseases as well.

### SUMMARY OF THE INVENTION

An embodiment of the invention is directed to a system for the detection of biomarkers in disease screening comprising: a capillary electrophoresis system with the capability of data acquisition; a gel polymer buffer, or molecular sieve in order to resolve the macromolecules from one another; and classification algorithms wherein the algorithms allow the system to discriminate between individuals with and without disease.

A further embodiment of the invention is directed to a method for the detection of biomarkers in disease screening utilizing sodium dodecyl sulfate (SDS) capillary gel electrophoresis (CGE) comprising: sample preparation steps; a script for the capillary electrophoresis software to produce the serum protein fingerprint; and statistical analysis methodology which includes algorithms and a programmed excel document. In certain embodiments, a website may be utilized to analyze data. The disclosed invention is capable of quantifying the impact of influential variables on the classification.

### BRIEF DESCRIPTION OF THE DRAWINGS

FIG. 1 shows the electrophoretic separation of a commercial protein preparation of known molecular weights. The electropherogram axes display migration time (minutes) versus absorbance units (AU);

FIG. 2 shows an exemplary serum protein fingerprint with the approximate molecular weights of macromolecules based on migration times;

FIG. 3 shows an example serum protein fingerprint;

FIG. 4 shows linear discriminant analysis (LDA) coefficients based on peak integrations from the serum profiles of CAD participants and Non-CAD participants;

FIG. 5 shows LDA scores calculated for each participant;

FIG. 6 shows a scale of the LDA scores of the participants in the study;

FIG. 7 shows an overview of participant biometric data;

FIG. 8 shows traditional CAD risk factor information for each participant of the study;

FIG. 9 shows a chart that depicts symptoms, comorbidities, and therapies of the study participants afflicted with CAD; and

FIG. 10 shows study participants with documented histories of CAD assigned to risk percentage groups based on their individual 10-year Framingham risk score (FRS) values.

### DESCRIPTION OF EXEMPLARY EMBODIMENTS

Embodiments of the invention are directed to a system for the detection of biomarkers in disease screening comprising: a capillary electrophoresis system with the capability of data acquisition; a gel polymer buffer, or molecular sieve in order to resolve the macromolecules from one another; and classification algorithms wherein the algorithms allow the system to discriminate between individuals with and without disease.

In an embodiment of the invention, capillary gel electrophoresis (CGE) is used to detect inherent differences in the serum protein profiles of subjects suffering from CAD and those who do not. This embodiment can be used to predict the existence of CAD, including silent CAD, i.e., CAD that does not display the onset of typical symptoms or overt clinical risk factors.

Embodiments of the invention are directed to methods of detection of biomarkers in disease screening utilizing sodium dodecyl sulfate (SDS) capillary gel electrophoresis (CGE) comprising: sample preparation steps; a script for the capillary electrophoresis software to produce the serum protein fingerprint; and statistical analysis methodology which includes algorithms and a programmed excel document. In certain embodiments, a website may be utilized to analyze data. The disclosed invention is capable of quantifying the impact of influential variables on the classification.

In certain embodiments, the methodology may be used directly in a hospital for point-of-care analysis, while in other embodiments, a commercial service may make use of the methodology in a blood testing laboratory. While certain embodiments may obtain blood samples through venipuncture, other embodiments may make use of alternate biofluid collection methods (e.g., a fingerstick method, wherein some embodiments of the fingerstick method may enable a microfluidic paper to be mailed with drops of blood from a fingerstick for diagnostic purposes.) Further embodiments of the invention may make use of the methodology to develop and test new drugs in the pharmaceutical industry as well as to track response to treatment.

Serum profiles may be generated by the SDS-CGE method for individuals with various diseases as well as healthy individuals. Univariate and multivariate analyses of the profile features may be conducted to detect or identify potential biomarkers associated with a disease, and statistically classify the status of a patient. Certain embodiments of the claimed invention may screen for CAD, while other embodiments may screen for other health problems caused by disease. Possible disease candidates include but are not limited to liver cirrhosis, monoclonal gammopathies, multiple sclerosis, gastrointestinal diseases, autoimmune diseases such as celiac disease or inflammatory bowel disease, acute pancreatitis, and cancers. Certain embodiments of the claimed invention may only allow for a binary screening while other embodiments may allow for the severity of the disease (e.g., based on a score) to be indicated.

An embodiment of the invention is directed to generating a macromolecule profile for the purpose of novel biomarker detection, disease screening, or disease diagnosis. In certain embodiments, separation of these biofluid macromolecules may be done using an on-line method to directly generate profiles by CGE for the purpose of performing univariate or multivariate differential analysis to identify single macromolecules or multiple macromolecules for the identification of health or disease. Commercial protein standards may be utilized to identify macromolecules of interest, such as those known to be present in the serum at high concentrations, those within the size limits of a gel buffer system, and those that are associated with disease, such as but not limited to C-Reactive Protein, Cardiac Phospholamban, and Serum Amyloid A.

Certain embodiments of the invention are directed towards the utilization of univariate analysis of variance (ANOVA) to identify biomarkers involved either directly or indirectly in health and disease by comparing the CGE profiles from the biofluid of diseased and/or apparently healthy individuals.

Certain embodiments of the invention are directed towards the utilization of multivariate analyses, such as but not limited to canonical analysis and/or linear discriminant analysis to identify biomarkers involved either directly or indirectly in health and disease by comparing the CGE profiles from the biofluid of diseased and/or apparently healthy individuals.

Certain embodiments of the claimed invention may also make use of multivariate (canonical and linear discriminant) analyses to generate algorithms and disease patterns from data obtained from CGE in order for data generated from diseased or apparently healthy serum profiles to be used to screen individuals of an unknown health status for disease(s).

Certain embodiments of the claimed invention may be used in tandem with other risk analysis, screening, or diagnostic techniques in order to generate a more robust, sensitive, or specific test method.

### WORKING EXAMPLES

Serum samples were collected from forty-eight (48) study participants—thirty (30) with known CAD and eighteen (18) without CAD at Scott & White Hospital, Temple, Tex. Adults greater than 18 years of age were eligible to participate in the study, and informed consent was obtained from each participant at the time of study enrollment. All participants fasted for 12 hours prior to sample collection, and the obtained data was de-identified and coded. The CAD participants were selected from a group of follow-up patients during study recruitment. The CAD cohort samples were collected at variable time intervals post-CAD diagnosis. The Non-CAD participants were selected from a group of patients who underwent angiographies due to possible cardiac symptoms. They were shown to have unremarkable angiograms with no arterial blockages. A medical history was acquired from each participant at the time of sample collection, which included gender, age, height, weight, race, family history of premature CVD, diabetes mellitus, hypertension, smoking habit/tobacco use (current and past), beta blockers, estrogen therapy, and a lipid panel. Additional data was collected from the CAD participants, including history of HDL levels <35 mg/dL, angina, myocardial infarction (MI), angioplasty and stent placement, coronary artery bypass graft (CABG), congestive heart failure (CHF), peripheral vascular disease (PVD), and chronic renal failure. Documented pharmaceutical histories for the CAD cohort participants also include the use of statins, fibrate, nicotinic acid, resin, thiazide, and alpha blockers. Samples were approved for research-use under Texas A&M University IRB study approval #IRB2014-0375M and Scott & White IRB study approval #90346.

Samples were collected into 9.5 mL Vacutainer® tubes treated with a polymer gel and silica activator, acquired from Beckton Dickinson Systems. The blood serum was separated from the other blood components by centrifugation at 3,200 rpm for 20.0 minutes at 5.0° C. The supernatant was then aspirated into labeled 500 μL Eppendorf tubes and stored in a −85.0° C. freezer from the time of collection. The samples are stored in the biorepository of the Texas A&M Laboratory for Cardiovascular Chemistry in College Station, Tex.

The Beckman Coulter P/ACE™ MDQ Capillary Electrophoresis System and associated 32 Karat Software was used with Beckman Coulter SDS-MW Kits for the analyses. This pairing affords a proven on-line gel buffer system. The SDS-MW Kit was purchased from AB Sciex, Pte. Ltd. (SKU#390953). The contents of the kit used in this study include the SDS Gel Separation Buffer, SDS Sample Buffer (100 mM Tris-HCL, pH 9.0, 1% SDS), SDS. Protein Sizing Standard (≧90% purity) ladder with proteins of molecular weights of 10, 20, 35, 50, 100, 150, and 225 kDa, Acidic Wash Solution (0.1 N HCl), Basic Wash Solution (0.1 N NaOH), and Separation Capillary (bare fused-silica) with internal diameter (I.D.) of 50 μm and outer diameter of (O.D.) 365 μm. De-ionized water was used in all instances water was called for in the method.

Capillaries were installed into the capillary cartridge with a total length of 31.2 cm and a separation length of 21 cm. The photo-diode array filter was set to λ214 nm. The temperature of the vial trays within the system was kept constant at 22° C.

For calibration purposes, the SDS Protein Sizing Standard was used as a protein ladder and was prepared using methodology from Beckman Coulter in which a 10.0 μL aliquot of the protein ladder was added to 40.0 μL of sample buffer. A 2.0 μL aliquot of β-Mercaptoethanol was then added to the solution and heated at 95.0° C. for five minutes and vortexed. The sample was degassed in a sonicating water bath for 5.0 minutes.

For the blood serum preparation, 25.0 μL of the serum sample was added to a sample vial containing 25.0 μL of sample buffer. The sample was then degassed in a sonicating water bath for 5.0 minutes. No other preparation of the serum was necessary.

The following steps are fully automated within the capillary electrophoresis system. The capillary is rinsed at 70.0 psi with vials of: 0.1 N NaOH for 3.00 minutes, 0.1 M HCl for 1.00 minute, and water for 1.00 minute. It is then filled with gel buffer at 70.0 psi for 10.00 minutes. Both ends of the capillary are dipped in water twice to clean the capillary tip prior to sample injection. The sample is injected into the capillary electrokinetically for 20.0 seconds using 5.0 kV. Both ends of the capillary are then dipped in water to prevent sample carry-over. The capillary is immersed in the gel buffer and proteins are separated by a 15.0 kV electric charge applied to the system for 45.00 minutes. As the proteins pass through the capillary window, the detector records the light transmittance and an electropherogram of the UV absorbance is generated in 32 Karat Software.

The raw data analysis provides information as to the areas of the profile peaks. Integrations of the electropherograms were performed in 32 Karat to determine individual peak areas. Integration events include a width value of 0.2 and a threshold limit of 75.0 for the whole separation. The integration was turned off in the first 8.5 minutes of the separation to reduce the data load from the background.

In order to create an automated method for the analysis of the peak integrations, a manual analysis first occurred in order to generate classification algorithms. The creation of a fast, clinically-useful automated analysis would not be possible without first having conducted the manual analysis.

The manual analysis consisted of selecting peaks that recur among specified points of the x-axis of numerous electropherograms generated from the serum of many individuals and recording the area of each peak. In order to improve peak selection, the profiles were stretched through the use of common intrinsic markers in serum. This resulted in the generation of a string of information derived from the raw data. This data was then copied into OriginPro 8.6 Data Analysis and Graphing Software. In conjunction with the string of information regarding peak integrations, each study participant's known CAD or Non-CAD medical status was incorporated for the purpose of providing training data in the OriginPro Software to generate classification equations to delineate CAD from Non-CAD participants.

Both univariate and multivariate analyses of the data were performed to examine potential biomarkers of CAD in this study. Univariate analysis identifies which profile features may independently contribute to a classification, whereas multivariate analysis identifies groups of profile features that may contribute to a classification. The univariate method selected is analysis of variance (ANOVA) for the identification of significant singular profile features for disease classification. Two types of multivariate analysis were selected to analyze the data: canonical analysis (CA) and linear discriminant analysis (LDA). Both of these multivariate analyses generated coefficients for each profile feature to suggest classification power and to generate equations from the coefficients. A cross validation rate for the training data was recorded to understand how the algorithms may apply to a larger sample size for predictive modeling. In Origin, the cross validation function removes each participant individually from the training data and determines the average accuracy with which they would be classified as test data.

For the CA and LDA methods, sensitivities were calculated by taking the number of participants classified as having CAD over the actual number of participants with CAD. The specificities of the CA and LDA methods were calculated by taking the number of participants classified as not having CAD over the actual number of participants without CAD.

In the manual analysis, the ranges of migration time and area in which each peak occurs were also studied. From this manually obtained data, an automated system of analysis was created. This is discussed in greater detail below.

Once the CA or LDA classification algorithm is generated, this formula can be used to plug in peak variables for each study participant. The following steps were taken in order to obtain the peak variables:

After analyzing the raw data using the aforementioned integration events, with the only difference being the time for which the integrations were turned off. Specifically, instead of starting the integration at 8.5 minutes, the migration time of the characteristic divot peak marks the beginning time for the integration. The Baseline feature of the 32 Karat Software is applied to the electropherogram to accurately record the divot time by ensuring a horizontal baseline across the top of the divot.

An Area Peak Report is generated in the 32 Karat Software which includes a table documenting the peak area values. The generated table of peak areas is then input into a preprogrammed Microsoft Excel worksheet. The programming was used for the purpose of automatically selecting specific peaks in the profile and replaces the need for the time-intensive manual selection. The programmed identification is based on time and intensity characteristics of the profile features. From this document, a string of information is generated that lists the areas of the specified peaks in each profile.

The Framingham risk scoring system was used to calculate 10-year coronary artery disease risk estimates for a subset of the total study population (N=29) based on their respective risk factors (i.e., ages, genders, total cholesterol, smoking statuses, HDL levels, and hypertension treatment statuses). Each risk factor had the potential to contribute to the participants' total Framingham point scores. Actual point values used for each risk category can be found on the NIH NHLBI Website: Estimate of 10-Year Risk for Coronary Heart Disease Framingham Point Scores. (National Institutes of Health, National Heart, Lung, and Blood Institute).

Because the Framingham score sets participant age limits to 20-79 years old, not all original study participants were eligible for the Framingham analysis. Additional participants were ineligible for a Framingham score because the required lipid panels were only available for 29 of the original 48 participants. Additionally, records of the systolic blood pressures were not available for the participants of our study, so a range of Framingham Scores were given to participants based on highest and lowest possible blood pressures instead of a true score. However, records of individuals taking blood pressure medicine were available and were taken into account. The Framingham point distribution system depends on the actual systolic blood pressure level and blood pressure treatment status. The following point scales are used: for men “0-2” points “If Untreated” and “0-3” points “If Treated” and for women “0-4” points “If Untreated” and “0-6 points” “If Treated”. For the Maximum Risk Score, the maximum value for each participant was assigned for the blood pressure score. Assigned maximum points also reflected whether the participant was being treated or was not treated for hypertension. For the Minimum Risk Score, a score of zero was assigned to each individual, as zero is the lowest available score for men or women regardless of whether or not their blood pressure was being treated. (National Institutes of Health, National Heart, Lung, and Blood Institute).

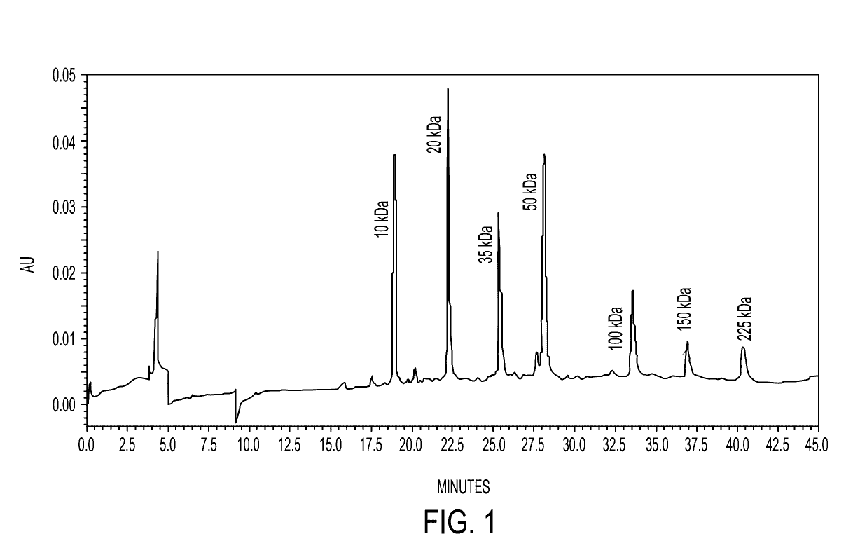

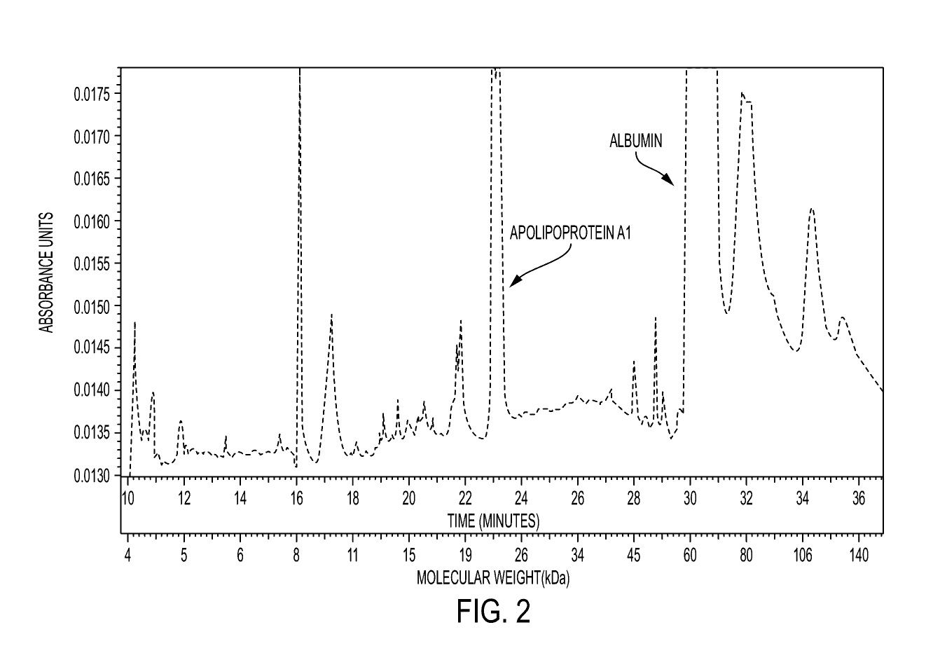

In an embodiment of the present invention, a serum protein fingerprint of a subject's serum sample is generated using gel electrophoresis to separate the proteins present in the sample. FIG. 1 shows the electrophoretic separation of a commercial protein preparation of known molecular weights. The electropherogram axes display migration time (minutes) versus absorbance units (AU). FIG. 2 shows an exemplary serum protein fingerprint with the approximate molecular weights of macromolecules based on migration times relative to the migration times of the commercial protein preparation in FIG. 1.

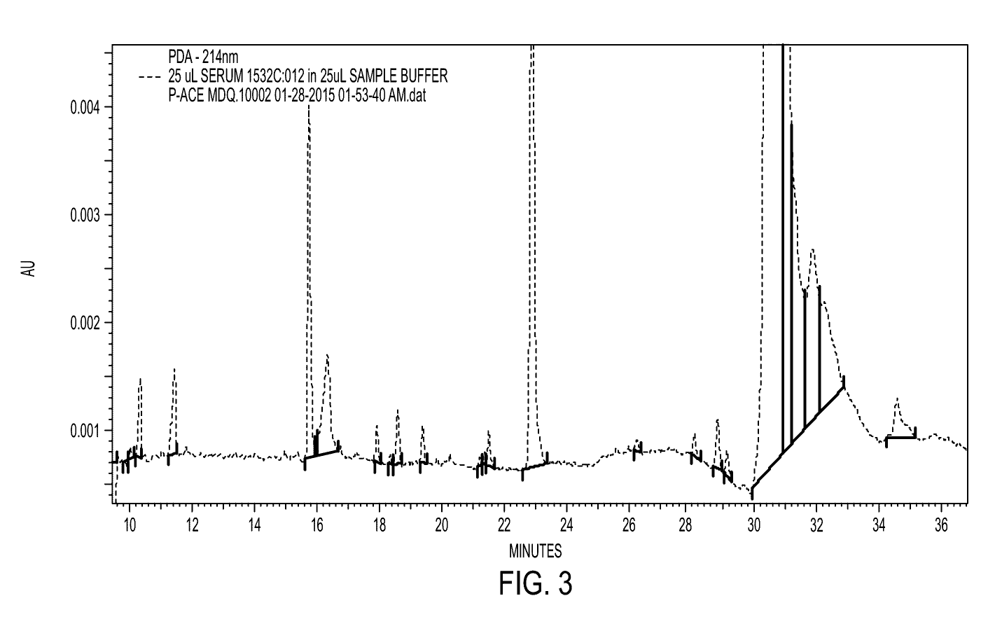

FIG. 3 shows a sample serum protein fingerprint of a subject sample. A baseline is applied to integrate the profile features and determine peak areas which are linearly related to the concentrations of the detected macromolecules shown in the electropherogram.

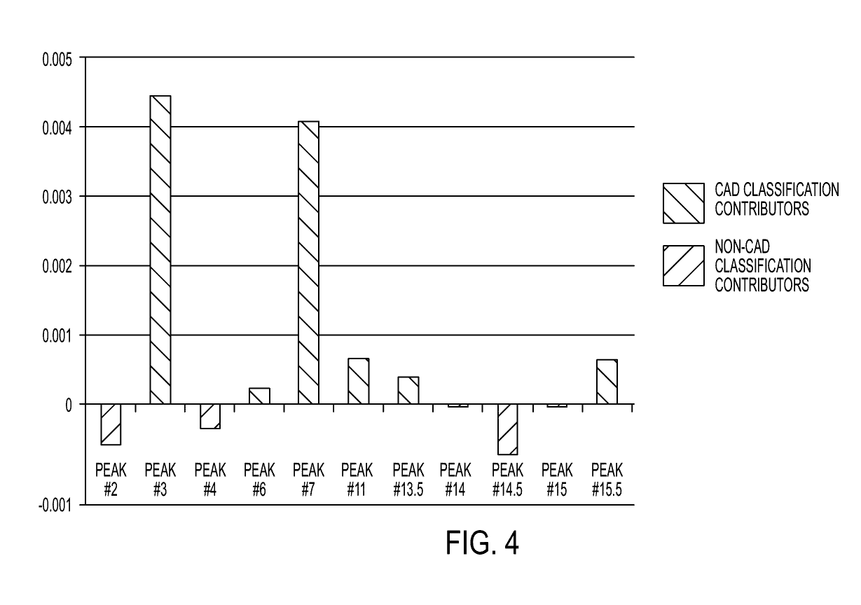

FIG. 4 shows linear discriminant analysis (LDA) coefficients based on peak integrations from the serum profiles of the thirty (30) CAD participants and the eighteen (18) Non-CAD participants. The x-axis consists of select peaks from the serum profiles and the y-axis represents the magnitude of the classification power of each profile peak. The peaks having values >0 indicate contributors to CAD classifications and may be markers of the disease. The peaks having values <0 indicate macromolecules that may be contributors to Non-CAD classifications and indicators of arterial health.

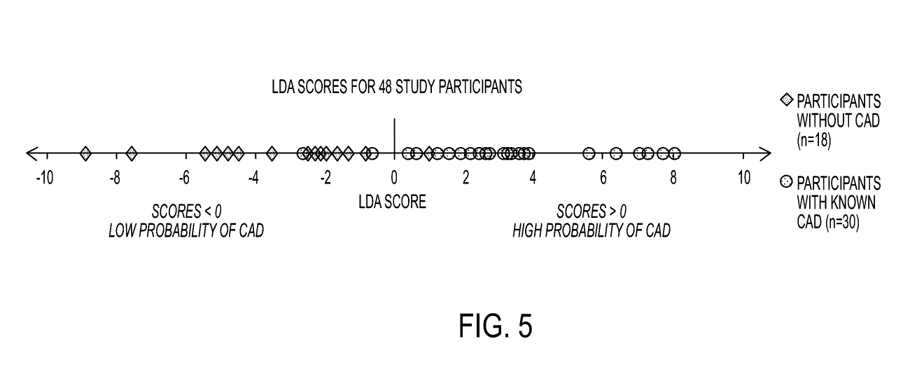

FIG. 5 shows LDA scores calculated for each participant. A negative score indicates a low probability of CAD. A positive score indicates a high probability of CAD. This method accurately discriminates between CAD and non-CAD participants with 93.8% accuracy, classifying 45 out of the 48 participants correctly.

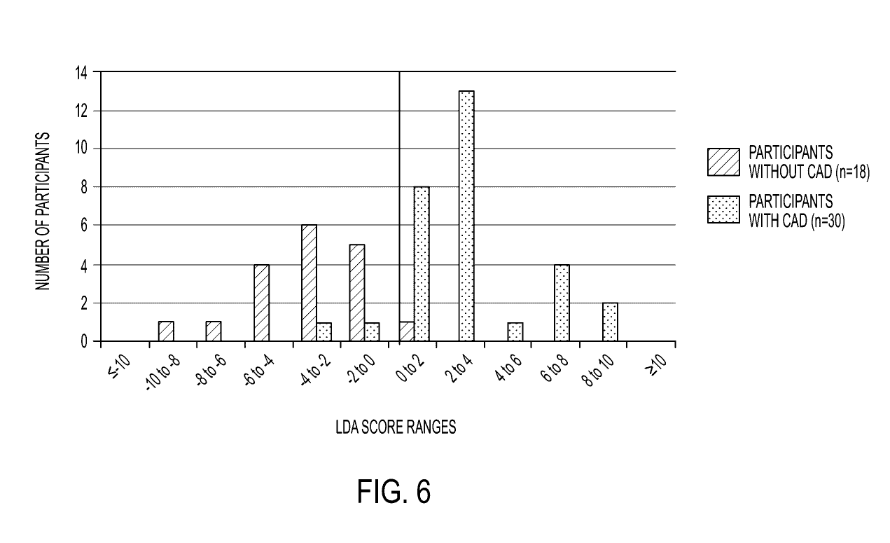

FIG. 6 shows a scale of the LDA scores of the participants in the study. The y-axis indicates the number of participants recorded with each score range. Thirty (30) participants were known to have CAD. Eighteen (18) participants were documented as having unremarkable coronary angiographies and no known medical history of CAD. Positive LDA scores (0 to 10) classify participants as having CAD. Negative LDA scores (−10 to 0) classify participants as not having CAD.

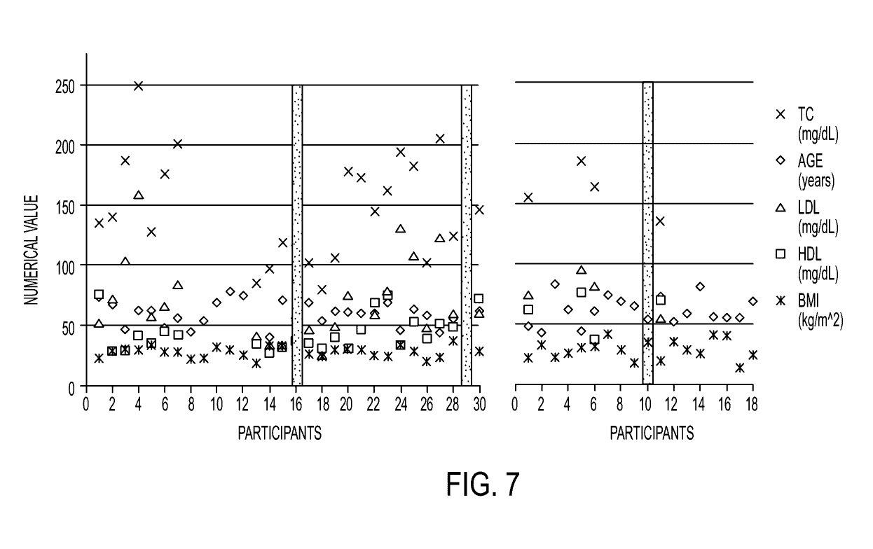

FIG. 7 shows an overview of participant biometric data displaying high density lipoprotein (HDL), low density lipoprotein (LDL), total cholesterol (TC), and body mass index (BMI) values for participants of CAD and Non-CAD cohorts. The numbers of the x-axes represent individual study participants. A symbol was assigned to each part of the biometric data. A symbol is included in a participant's column if they have the referenced risk factor. The dotted columns indicate participants whose CAD or Non-CAD health statuses were misidentified by the LDA equation. Participants 16 and 29 of the CAD cohort and participant 10 of the Non-CAD cohort were misclassified by the LDA equation.

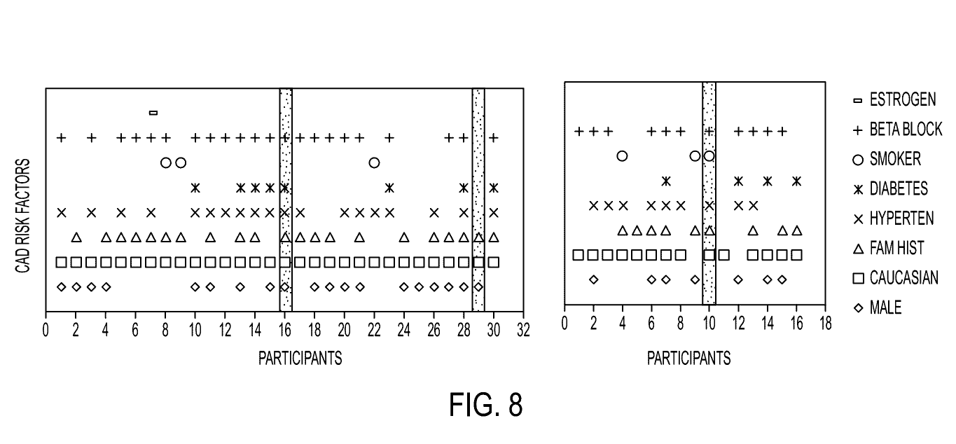

FIG. 8 shows traditional CAD risk factor information for each participant of the study. The numbers of the x-axes represent individual study participants. A symbol was assigned to each risk factor. A symbol is included in a participant's column if they have the referenced risk factor. Risk factors covered in this figure include the use of estrogen or beta blocker therapy, the male gender, Caucasian race, smoking status, and whether an individual has diabetes, hypertension, or a family history of CAD. The dotted columns indicate participants whose CAD or Non-CAD health statuses were misidentified by the LDA equation. Participants 16 and 29 of the CAD cohort and 10 of the Non-CAD cohort were incorrectly classified by the LDA equation.

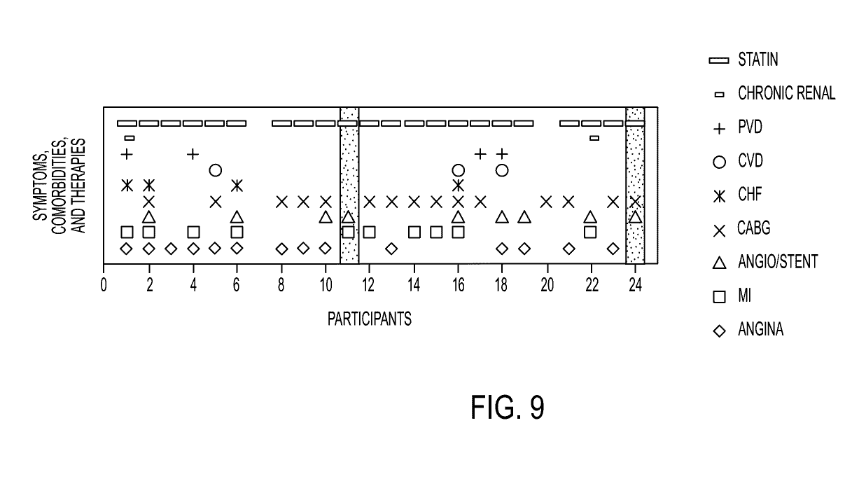

FIG. 9 shows a chart that depicts symptoms, comorbidities, and therapies of the study participants afflicted with CAD. The numbers of the x-axis represent individual study participants. A symbol was assigned to each symptom, comorbidity, and therapy. A symbol is included in a participant's column if they have one or more of the symptoms, comorbidities, or therapies included in the chart. Individual medical history documentation includes statin use, angina, myocardial infarction (MI), angioplasty/stent (Angio/Stent), Coronary artery bypass graft (CABG), congestive heart failure (CHF), cardiovascular disease (CVD), peripheral vascular disease (PVD), and chronic renal failure (Chronic Renal). The dotted columns indicate participants who were misclassified as belonging to the Non-CAD cohort by the LDA equation. Participants 11 and 24 were incorrectly classified by the LDA equation.

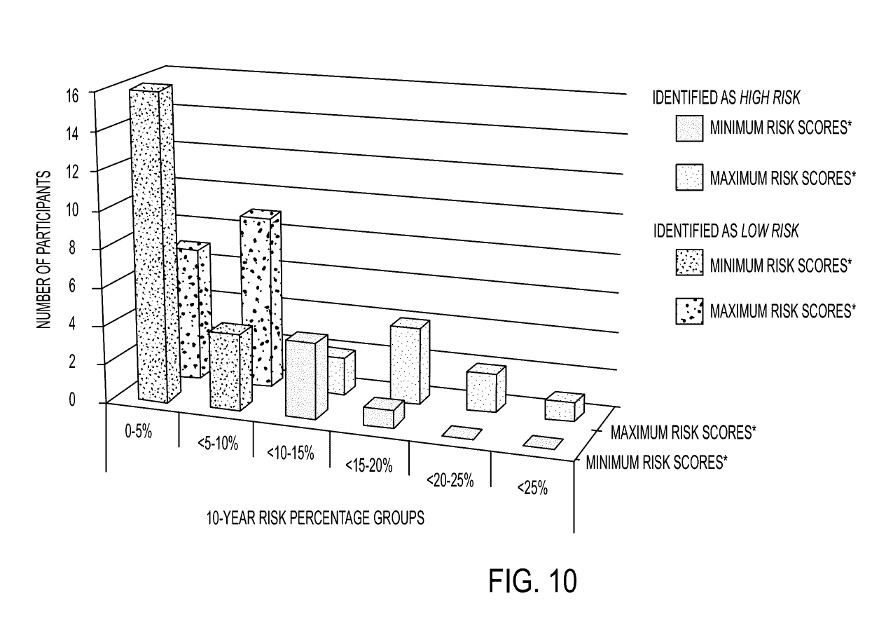

FIG. 10 shows twenty-five (25) study participants with documented histories of CAD assigned to risk percentage groups based on their individual 10-year Framingham risk score (FRS) values. The x-axis depicts the 10-year risk percentage groups. The number of participants in each group is identified by the y-axis of the table. The Framingham method estimates an individual's risk level of having a cardiac event or of developing CAD in the next 10 years. Framingham scores were generated from medical records. Information for blood pressure (BP) was not available. However, the Framingham method requires BP for the FRS calculation. To overcome this, both minimum and maximum FRS values were calculated by subbing in the potential minimum and maximum BP values for each individual, respectively.* These minimum and maximum FRS ranges encompass the true FRS scores. This information can then be compared to the known medical history of each individual and a range of possible accuracies for the FRS method can be obtained. This figure depicts the poor sensitivity of the FRS method in the screening of these CAD study participants.

Table 1 details the Univariate ANOVA output for data from 30 individuals with CAD and 18 ‘Non-CAD’ individuals. Rows for Peak #s 3 and 7 in the table have values of Prob>F being smaller than 0.05, indicating the differences in the group means of the CAD and Non-CAD groups for these peaks are significant. Other peaks of potential significance (having Prob>F values <0.1), include Peak #s 6, 13.5, and 15.5. Peaks were numbered according to the profile of FIG. 3.

TABLE 1
Univariate ANOVA (analysis of variance) output from OriginLab Software

| | R-Square | F Value | df | df2 | Prob > F |
|---|---|---|---|---|---|
| Peak #2 | 3.68812E−4 | 0.01697 | 1 | 46 | 0.89692 |
| Peak #3 | 0.13708 | 7.30739 | 1 | 46 | 0.00959 |
| Peak #4 | 0.01828 | 0.85652 | 1 | 46 | 0.35954 |
| Peak #6 | 0.07461 | 3.7085 | 1 | 46 | 0.06033 |
| Peak #7 | 0.30802 | 20.47606 | 1 | 46 | 4.24233E−5 |
| Peak #11 | 0.00856 | 0.3973 | 1 | 46 | 0.5316 |
| Peak 13.5 | 0.06303 | 3.09438 | 1 | 46 | 0.08521 |
| Peak #14 | 0.02628 | 1.24145 | 1 | 46 | 0.27098 |
| Peak #14.5 | 0.04364 | 2.09916 | 1 | 46 | 0.15416 |
| Peak #15 | 0.04902 | 2.37115 | 1 | 46 | 0.13045 |
| Peak #15.5 | 0.06303 | 3.09449 | 1 | 46 | 0.08521 |

The Linear Discriminant Analysis (LDA) algorithm was generated from the classification analysis of the forty-eight (48) study participants in Equation 1 shown below:

LDA Score=−0.000579578*X₂+0.00445*X₃+−0.00034619*X₄+0.000228521X₆+0.00407X₇+0.000657798X₁₁+0.000384725X_{13.5}+−3.18737E-05X₁₄+−0.000719461 X_{14.5}+−2.72912E-05X₁₅+0.000631111X_{15.5}+2.73956

A positive LDA score was found to suggest that a patient has CAD. A negative score suggests that the patient does not have detectable levels of CAD (FIG. 5).

Of the 48 study participants, 94% were correctly classified as having or not having coronary artery disease (CAD versus NonCAD) with relative standard deviations of 2% for molecular weight and 20% for absorbance indicate method repeatability. In the classification of participants as CAD or NonCAD, the respective accuracies of the multivariate canonical and linear discriminant analyses were 90% (p-value of 7E-5 indicates a high statistical significance) and 94%. Furthermore, two features of the serum profiles (peak #'s 3 and 7 (with Prob>F values of 0.01 and 4E-5 respectively)) are potentially novel biomarkers for CAD. The ability of the methodology to detect and identify new biomarkers may also add to its applicability in basic or clinical research.

To compare the accuracy of the method with that of an established clinical tool, participants' 10-Year Framingham Risk Scores (FRS) were calculated. Framingham calculates the percent risk an individual has of developing coronary artery disease or having a cardiac event in the next 10 years. Individuals with FRS scores less than 10% risk (clinically interpreted as low risk) were classified as Non-CAD and those with greater than 10% risk (clinically interpreted as moderate to severe risk) were classified as CAD for the purpose of comparing the two methods. The classification accuracy of FRS in the present analysis was less than 42%.

The novel proposed method was shown to be more accurate than the most widely used clinical method, the Framingham Risk Score analysis, for determining an individual's risk of coronary artery disease.

While the present invention has been described in terms of certain preferred embodiments, it will be understood, of course, that the invention is not limited thereto since modifications may be made to those skilled in the art, particularly in light of the foregoing teachings.

What is claimed is:

1. A system for the detection of biomarkers in disease screening comprising:
a capillary electrophoresis system with the capability of data acquisition; and
classification algorithms that identify individuals having markers for a specific disease.

2. The system of claim 1, wherein the capillary electrophoresis system is a gel electrophoresis system.

3. The system of claim 2, wherein the gel electrophoresis system is a sodium dodecyl sulfate (SDS) capillary gel electrophoresis system.

4. The system of claim 2, wherein the gel electrophoresis system is a polymer sieving gel electrophoresis system.

5. The system of claim 2, wherein the gel electrophoresis system comprises sample preparation tools.

6. The system of claim 2, wherein the gel electrophoresis system comprises a script that produces a serum protein fingerprint.

7. The system of claim 1, wherein the capillary electrophoresis system separates biofluid macromolecules into single macromolecules or multiple macromolecules.

8. The system of claim 1, wherein the classification algorithms analyze the data obtained from the capillary gel electrophoresis system.

9. The system of claim 8, wherein the analysis is carried out by univariate analysis.

10. The system of claim 8, wherein the analysis is carried out by multivariate analysis.
